(19) United States
(12) Patent Application Publication
(10) Pub. No.: US 2017/0166136 A1
(43) Pub. Date: Jun. 15, 2017

(54) DOCUMENT STORAGE SYSTEM

(71) Applicant: Charles Jones, Indianapolis, IN (US)

(72) Inventor: Charles Jones, Indianapolis, IN (US)

(21) Appl. No.: 14/963,440

(22) Filed: Dec. 9, 2015

(51) Int. Cl. B60R 7/05; B65D 33/25; B60R 7/08

(52) U.S. Cl. CPC B60R 7/05; B60R 7/08; B65D 33/2591

(57) ABSTRACT

A document storage system includes a vehicle that has a visor. A pouch is provided and the pouch may contain documents. The pouch is removably coupled to the visor and the pouch is substantially comprised of a translucent material. Thus, the documents are visible within the pouch. A pair of clips is provided and each of the clips is coupled to the pouch. Each of the clips engages the visor.

### BACKGROUND OF THE DISCLOSURE

Field of the Disclosure

The disclosure relates to storage devices and more particularly pertains to a new storage device for storing documents in a vehicle such that the documents are visible.

### SUMMARY OF THE DISCLOSURE

An embodiment of the disclosure meets the needs presented above by generally comprising a vehicle that has a visor. A pouch is provided and the pouch may contain documents. The pouch is removably coupled to the visor and the pouch is substantially comprised of a translucent material. Thus, the documents are visible within the pouch. A pair of clips is provided and each of the clips is coupled to the pouch. Each of the clips engages the visor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a document storage system according to an embodiment of the disclosure.

FIG. 2 is a front view of an embodiment of the disclosure.

FIG. 3 is a back view of an embodiment of the disclosure.

FIG. 4 is a cross sectional view taken along line 4-4 of FIG. 2 of an embodiment of the disclosure.

FIG. 5 is a perspective in-use view of an embodiment of the disclosure.

### DESCRIPTION OF THE PREFERRED EMBODIMENT

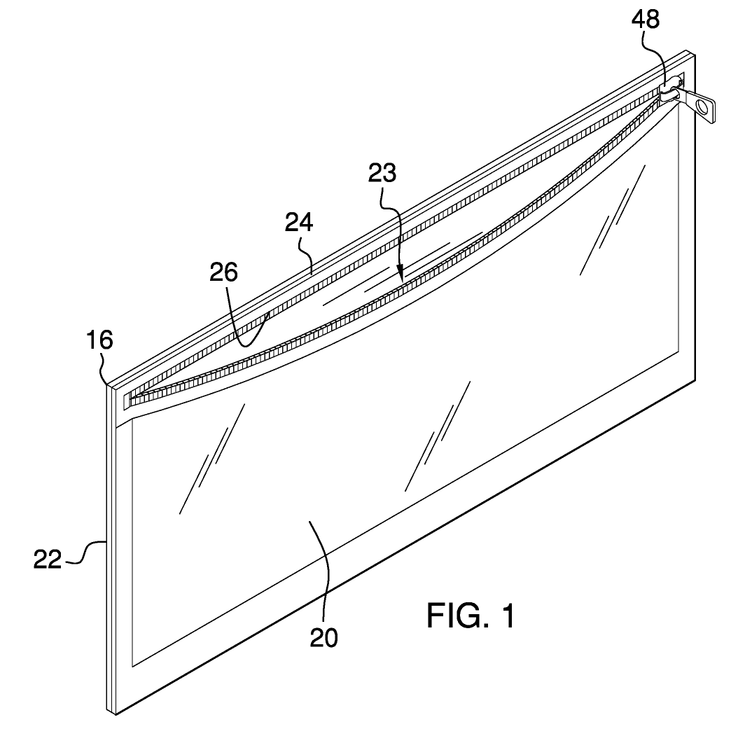

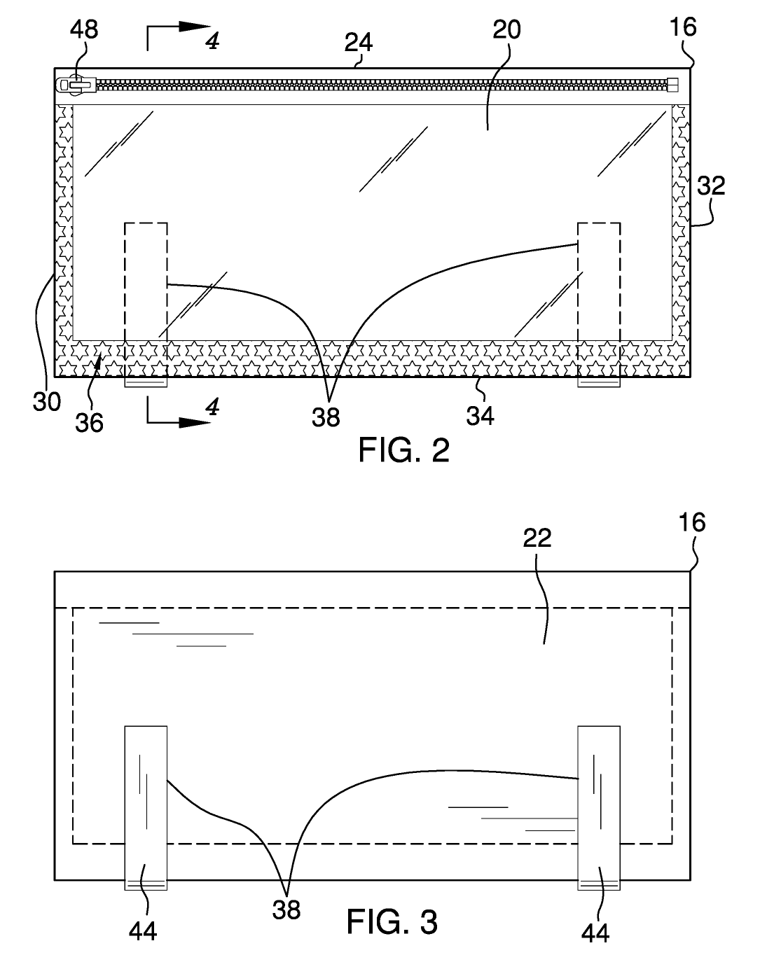

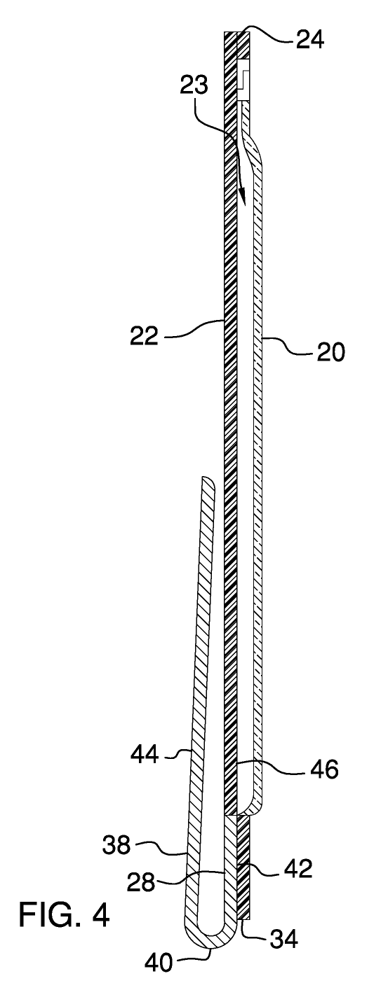

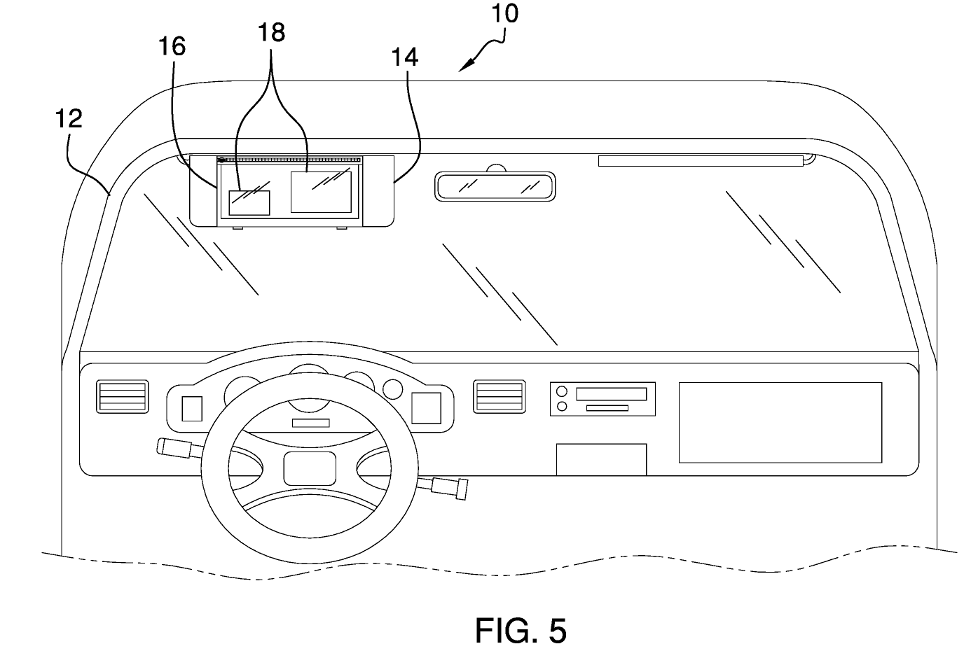

With reference now to the drawings, and in particular to FIGS. 1 through 5 thereof, a new storage device embodying the principles and concepts of an embodiment of the disclosure and generally designated by the reference numeral 10 will be described.

As best illustrated in FIGS. 1 through 5, the document storage system 10 generally comprises a vehicle 12 that has a visor 14. The vehicle 12 may be a passenger vehicle or the like. A pouch 16 is provided and the pouch 16 may contain documents 18. The pouch 16 is removably coupled to the visor 14. The pouch 16 is substantially comprised of a translucent material such that the documents 18 within the pouch 16 are visible. The documents 18 may comprise a vehicle registration, insurance cards or other documents related to the operation of the vehicle.

The pouch 16 has front side 20 and a back side 22. The front side 20 is attached to the back side 22 along an entire perimeter of the pouch 16 to define a space 23 within the pouch 16. The front side 20 has a top edge 24. The front side 24 has a cut 26 extending through the front side 20 to access the space 23. Thus, the cut 26 allows the documents 18 to be positioned within the space 23.

The cut 26 is positioned adjacent to the top edge 24 and the cut 26 is substantially coextensive with the top edge 24. The front side 20 is substantially comprised of the translucent material. The back side 22 has a bottom edge 28 and the front side 20 extends downwardly beyond the bottom edge 28. The bottom edge 28 is coupled to the front side 24.

The front side 24 has a first lateral edge 30, a second lateral 32 and a lower edge 34. The front side 24 may have indicia 36 printed thereon. The indicia 36 may define a border that is coextensive with each of the first lateral edge 30, the second lateral edge 32 and the lower edge 34. The indicia 36 may comprise geometric shapes or the like thereby enhancing an appearance of the pouch 16.

A pair of clips 38 is provided and each of the clips 38 has a central portion 40 extending between a front portion 42 and a rear portion 44. The front portion 42 and the rear portion 44 are spaced apart from each other. The rear portion 44 has a length that is greater than a length of the front portion 42. The front portion 42 has a top edge 46.

The top edge 46 of each of the clips 38 is coupled to the bottom edge 28 of the back side 22. The rear portion 44 extends upwardly along the back side 22. The front side 24 substantially covers the front portion 42 of each of the clips 38. The rear portion 44 of each of the clips 38 is spaced from the back side 22. Thus, the visor 14 is positionable between the rear portion 44 of each of the clips 38 and the back side 22. The rear portion 44 of each of the clips 38 is biased toward the back side 22 such that each of the clips 38 frictionally engages the visor 14. Thus, the pouch 16 is removably retained on the visor 14.

A closure 48 is coupled to the pouch 16. The closure 48 may be manipulated. The closure 48 is aligned with the cut 26 such that the closure 48 selectively opens and closes the cut 26. The closure 48 may comprise a zipper or the like.

In use, the visor 14 is positioned between the clips 38 and the pouch 16 such that the front side 20 of the pouch 16 is exposed on the visor 14. The closure 48 is manipulated to open the cut 26 and the documents 18 are inserted into the pouch 16. The documents 18 are positioned such that the documents 18 can be read through the front side 20. The closure 48 is manipulated to close the cut 26.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is u sed in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A document storage system comprising:
a vehicle having a visor;
a pouch being configured to contain documents, said pouch having a back side and a front side, said back side said having a bottom edge, said pouch being removably coupled to said visor, said pouch being substantially comprised of a translucent material wherein said pouch is configured to facilitate the documents to be visible;
a pair of clips, each of said clips being coupled to said pouch, each of said clips engaging said visor, wherein each of said clips has a central portion extending between a front portion and a rear portion, said front portion and said rear portion being spaced apart from each other, said rear portion having a length being greater than a length of said front portion, said front portion having a top edge; and
wherein said top edge of each of said clips is coupled to said bottom edge of said back side such that said rear portion extends upwardly along said back side, said front side substantially covering said front portion of each of said clips, said rear portion of each of said clips being spaced from said back side such that said visor is positionable between said rear portion of each of said clips and said back side.

2. The system according to claim 1, wherein said pouch has a front side and a back side, said front side being attached to said back side along an entire perimeter of said pouch to define a space within said pouch, said front side having a top edge, said front side having a cut extending through said front side to access said space wherein said cut is configured to allow the documents to be positioned within said pouch, said cut being positioned adjacent to said top edge, said cut being substantially coextensive with said top edge, said front side being substantially comprised of said translucent material.

3. The system according to claim 2, wherein said back side has a bottom edge, said front side extending downwardly beyond said bottom edge, said bottom edge being coupled to said front side.

4. (canceled)

5. (canceled)

6. The system according to claim 1, wherein said rear portion of each of said clips is biased toward said back side having each of said clips frictionally engaging said visor such that said pouch is removably retained on said visor, said clips being spaced apart from each other and distributed along said bottom edge.

7. The system according to claim 2, further comprising a closure being coupled to said pouch wherein said closure is configured to be manipulated, said closure being aligned with said cut such that said closure selectively opens and closes said cut.

8. A document storage system comprising:
a vehicle having a visor;
a pouch being configured to contain documents, said pouch being removably coupled to said visor, said pouch being substantially comprised of a translucent material wherein said pouch is configured to facilitate the documents to be visible, said pouch having front side and a back side, said front side being attached to said back side along an entire perimeter of said pouch to define a space within said pouch, said front side having a top edge, said front side having a cut extending through said front side to access said space wherein said cut is configured to allow the documents to be positioned within said pouch, said cut being positioned adjacent to said top edge, said cut being substantially coextensive with said top edge, said front side being substantially comprised of said translucent material, said back side having a bottom edge, said front side extending downwardly beyond said bottom edge, said bottom edge being coupled to said front side;
a pair of clips, each of said clips having a central portion extending between a front portion and a rear portion, said front portion and said rear portion being spaced apart from each other, said rear portion having a length being greater than a length of said front portion, said front portion having a top edge, said top edge of each of said clips being coupled to said bottom edge of said back side such that said rear portion extends upwardly along said back side, said front side substantially covering said front portion of each of said clips, said rear portion of each of said clips being spaced from said back side such that said visor is positionable between said rear portion of each of said clips and said back side, said rear portion of each of said clips being biased toward said back side having each of said clips frictionally engages said visor such that said pouch is removably retained on said visor; and
a closure being coupled to said pouch wherein said closure is configured to be manipulated, said closure being aligned with said cut such that said closure selectively opens and closes said cut.
